(19) United States
(12) Patent Application Publication
(10) Pub. No.: US 2009/0156193 A1
(43) Pub. Date: Jun. 18, 2009

(54) Modem with acoustic coupling

(76) Inventors: Milos Urbanija, Izlake (SI); Amor Chowdhury, Gornja Radgona (SI); Gregor Golobic, Ljublijana (SI)

Correspondence Address: MCDERMOTT WILL & EMERY LLP, 600 13TH STREET, N.W., WASHINGTON, DC, 20005-3096, US

(21) Appl. No.: 11/990,809

(22) PCT Filed: Aug. 22, 2005
(86) PCT No.: PCT/EP2005/009063

§ 371 Date: Dec. 11, 2008

(51) Int. Cl. H04M 3/00

(52) U.S. Cl. 455/420

(57) ABSTRACT

The present invention relates to a terminal interface and an arrangement including the terminal interface to enable interfacing between an electronic device and a service provider. The terminal interface comprises at least a data interface arranged for coupling the terminal interface to the electronic device, a processing means adapted to operate the terminal device, and modem means enabling data communication between the interface terminal and a terminal device enabled for voice commutation in a public land mobile communications network. The data processing means coupled to the data interface and the modem means is further configured for processing data received from either of the data interface and the modem means and for generating data to be transmitted via the data interface and/or the modem means. Data is communicated between the interface terminal and the service provider via the terminal device on a voice communication connection through the public land mobile communications network.

The present invention relates substantially to a terminal interface and arrangement enabling monitoring, maintenance, and, service data exchange especially between appliance devices and service centers.

Mobile telephony is booming throughout the world and provides many recently developed applications in data communication. One main advantage of mobile telephony is the availability at any place at any time. Up to now, this availability advantage is primarily used for voice call conversation. Rather, use case applications including the capability of mobile telephony are currently developing. When referring to maintenance service of typical electronic devices like households appliances, vehicles, and the like or maintenance of devices for strict purpose like production machines it is immediately apparent that activity monitoring of those devices. In near future, the triumphant process in the development in electronics especially controller—as well as processor-based electronics will result in a majority of contemporary appliances controlled on the basis of program code sections and software programs. Such controller-based and processor-based devices can be prepared for remote software maintenance and operation monitoring. Up to now, the majority of such devices is still not applicable for being accessed via telecommunication connection such that long distance monitoring, service support and software maintenance is not applicable.

The object of the present invention is to enable telecommunication-based access by the means of a universal terminal interface to a service center, which operates substantially independently from any specific telecommunication standard.

It is desirable to have a terminal interface that is very simple, fast, easy, and user-friendly in its use.

It is further desirable to have a simple, fast, and reliable system with a minimum coupling between a mobile terminal device capable for telecommunications and the terminal interface.

This object is solved by a terminal interface according to claim 1.

Advantageously the communication media used for data exchange between terminal interface and service center is a voice/audio communication connection of any known or future telecommunication system such as public subscriber telephone network (PSTN), Global System for Mobile Communication (GSM), Universal Mobile Telecommunications System (UMTS), and the like. In cases where appliance is already connected in to a communication system such as a wide area network (e.g. the Internet) or a public subscriber telephone network (PSTN) the present invention provides an advantageous concept for authentication and/or authorization applicable with long distance monitoring, service support and software maintenance.

According to an aspect of the present invention, a terminal interface is provided, which interfaces between an electronic device and a service provider. The terminal interface comprises at least a data interface arranged for coupling the terminal interface to the electronic device, a processing means adapted to operate the terminal device, and modem means enabling data communication between the interface terminal and a terminal device enabled for voice commutation in a mobile communications network. The data processing means coupled to the data interface and the modem means is further configured for processing data received from either of the data interface and the modem means and for generating data to be transmitted via the data interface and/or the modem means. Data is communicated between the interface terminal and the service provider via the terminal device on a voice communication connection through the mobile communications network. In particular, the mobile communications network is a public land mobile network (PLMN), a satellite mobile network (SMN) and/or an internet phone mobile network (IPMN).

According to an embodiment of the present invention, the terminal interface comprises also coupling means arranged for releasable coupling the terminal device to the interface device.

According to an embodiment of the present invention, the modem means is arranged for converting acoustically coded information received from the terminal device via an acoustic interface of the coupling means into converted data to be sent to the processing means and for converting data received from the processing means into acoustically coded information to be sent via the acoustic interface. This means the data converted into acoustically coded information use voice/audio as a signal carrier for data communication.

According to an embodiment of the present invention, the acoustic interface provides an acoustic transducer, which is arranged for generating one or more acoustic signals, and/or an acoustic sensor, which is arranged for detecting acoustic signals. The acoustic interface is intended for acoustic coupling to an audio interface of the terminal device. In particular, the acoustic transducer may be a loudspeaker or speaker, whereas the acoustic sensor may be a microphone. The audio interface of the terminal device comprises typically a speaker for reproducing audio/voice and a microphone for recording audio/voice.

According to an embodiment of the present invention, the electronic device is an on-board diagnostic system of a vehicle. The on-board diagnostic system provides diagnostic data, which comprises diagnostic information and/or sensor information obtained from engines, systems, modules and components of the vehicle e.g. on the basis of sensors. The data is to be transmitted to the service provider, who provides monitoring, support, and/or maintenance services for the vehicle.

According to an embodiment of the present invention, the diagnostic data is to be transmitted in accordance with a malfunction indication, which is provided by the on-board diagnostic system or which is generated by the interface terminal on the basis of the diagnostic data obtained from the on-board diagnostic system via the data interface.

According to an embodiment of the present invention, the diagnostic data is buffered by the interface terminal. The buffered diagnostic data is to be transmitted to the service provider to enable monitoring of an operation of the vehicle.

According to an embodiment of the present invention, the electronic device is an appliance device, which operation is controlled on the basis of program code. The appliance device provides operation related data and/or sensor data, which is obtainable via the data interface of the terminal interface. The data provided by the appliance device is intended to be communicated to the service provider, who provides monitoring, support, and/or maintenance services for the appliance device.

According to an embodiment of the present invention, the interface terminal is arranged to receive reconfiguration data from the service provider. The reconfiguration data is intended for reconfiguring the appliance device. The reconfiguration data comprises reconfiguration parameters, program code for reconfiguration, and/or new program code for replacement.

According to an embodiment of the present invention, the terminal interface comprises a terminal identifier for establishing its authorization at the service provider.

According to an embodiment of the present invention, the interface terminal is arranged to transmit additionally payment-related information to the service provider, who offers payment transaction services.

According to another aspect of the present invention, a system is provided, which comprises a terminal interface, which interfaces between an electronic device and a service provider. The terminal interface comprises at least a data interface arranged for coupling the terminal interface to the electronic device, a processing means adapted to operate the terminal device, and modem means enabling data communication between the interface terminal and a terminal device enabled for voice commutation in a mobile communications network. The data processing means coupled to the data interface and the modem means is further configured for processing data received from either of the data interface and the modem means and for generating data to be transmitted via the data interface and/or the modem means. Data is communicated between the interface terminal and the service provider via the terminal device on a voice communication connection through the mobile communications network.

According to an embodiment of the present invention, the terminal device is operable with any mobile voice communication technology.

According to an embodiment of the present invention, the service provider and the electronic device are connectable via a direct communication connection, which is used for direct data communication after establishing of an authorization via the terminal device coupled to the modem means of the interface terminal and enabled for over-the-air voice communication with the mobile communications network.

According to an embodiment of the present invention, the system comprises additionally a payment center, which is comprised by or associated with the service provider. The interface terminal is arranged to transmit additionally payment-related information to the service provider, who offers payment transaction services.

Further advantageous embodiments of the invention are mentioned in the dependent claims.

Further advantages, advantageous embodiments, and additional applications of the invention are provided in the following description of embodiments of the invention in connection with the figures being enclosed, where

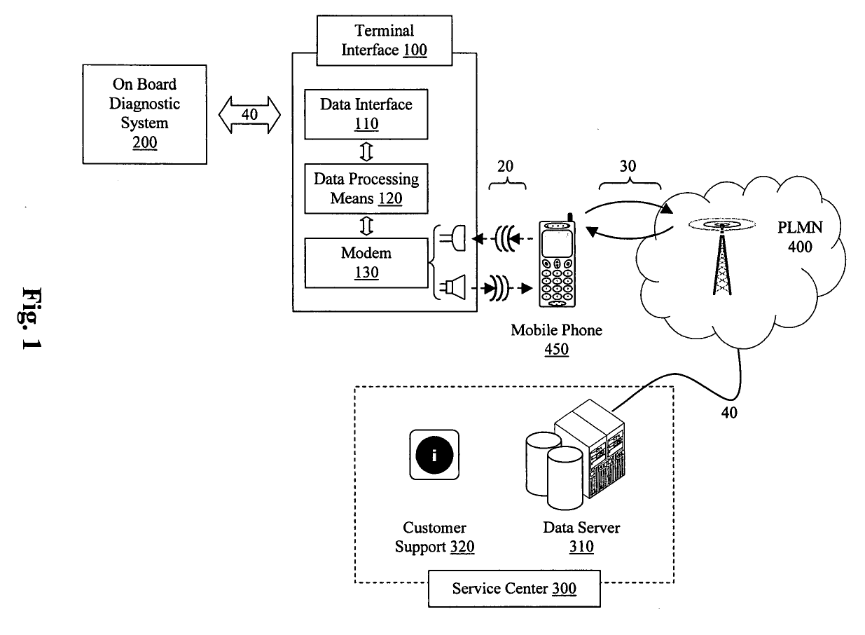

FIG. 1 shows a block diagram illustrating a first arrangement according to an embodiment of the present invention;

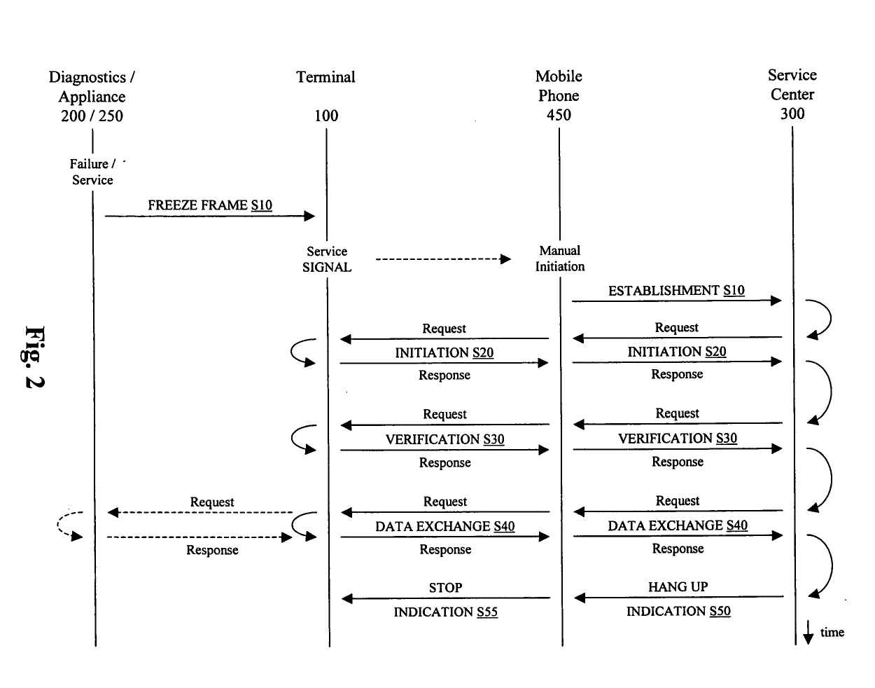

FIG. 2 shows a flow diagram illustrating an operational sequence according to an embodiment of the present invention;

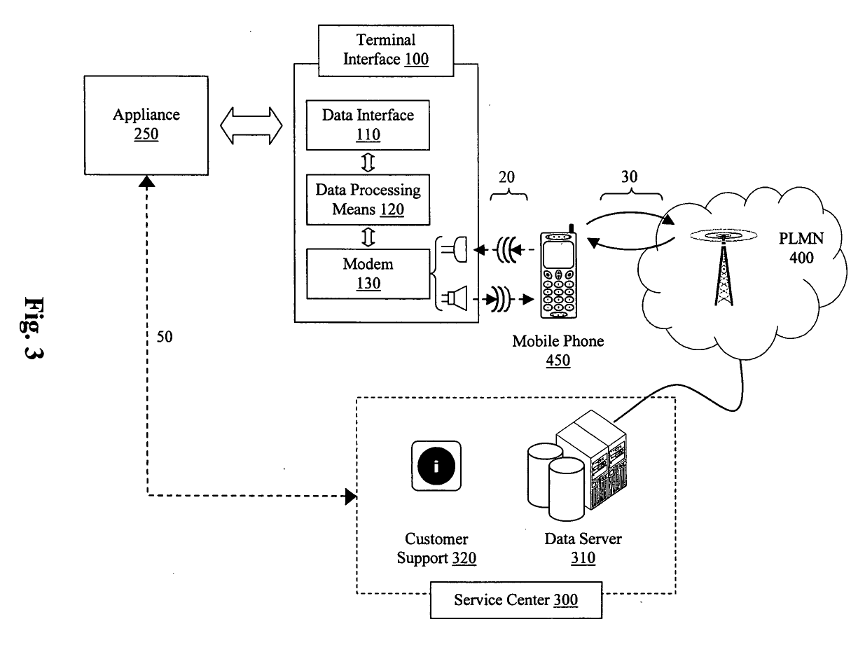

FIG. 3 shows a block diagram illustrating another arrangement according to another embodiment of the present invention; and

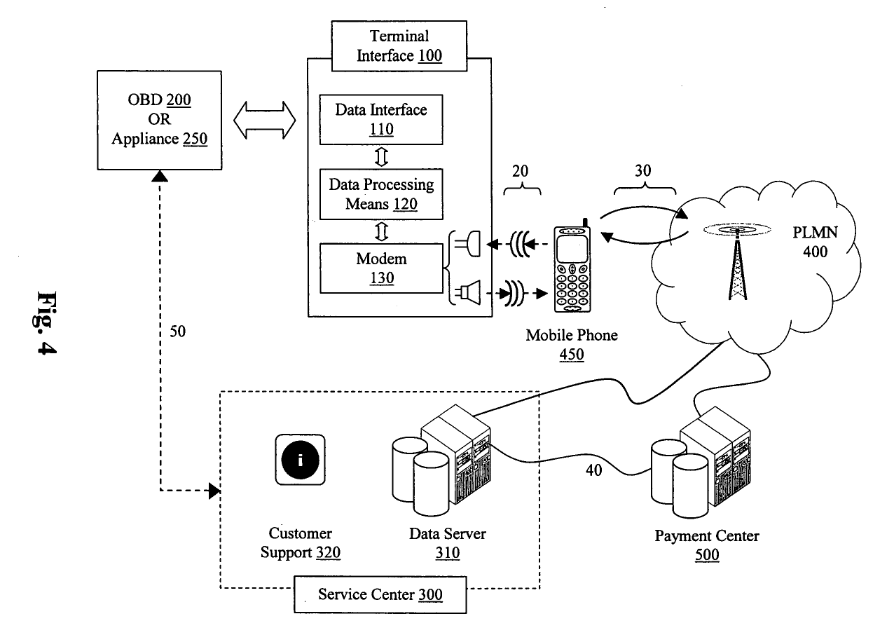

FIG. 4 shows a block diagram illustrating still another arrangement according to a further embodiment of the present invention.

Same or similar components in the drawing are referred to by the same reference numbers.

With reference to FIG. 1, a first embodiment of the present invention is illustrated. The arrangement shown in FIG. 1 illustrates a terminal interface 100 for monitoring, maintenance, and service data exchange comprising an interface for coupling to an appliance, herein an on-board diagnostics system 200, from which monitoring maintenance, and service data is obtained, and an interface to a mobile phone 450, which enables voice/audio communication form the terminal interface 100 to a service center 300 or, vice versa, from the service center 300 to the terminal interface 100. The data transmission is performed via a voice/audio communications channel established in-between the mobile phone 450 and the service center 300 preferably via a public land mobile network 400. In particular, the service center 300 offers services via a server 310 including for instance a subscriber data base and an interface allowing for voice/audio communication via a connection to a voice/audio communication network such as the public land mobile network (PLMN) 400.

It should be noted that the public land mobile network (PLMN) is one specific embodiment of a voice communications network. The present invention is not limited to the public land mobile network (PLMN). Rather, any network enabled for voice/audio communications services is operable with the present invention including in particular a public land mobile network (PLMN) of any mobile voice communications technology, any satellite mobile network (SMN), and/or any internet phone mobile network (IPMN). Those skilled in the art will appreciate that any currently available or future technology enabling for mobile voice/audio communications services may be employable with the inventive concept illustrated on the basis of embodiments.

Today, on-board diagnostic systems 1 are widely implemented in motor vehicles including especially cars and light trucks. Such on-board diagnostic systems are implemented to follow in particular for the complexity of today's controlling electronics in combustion engines and supporting aggregates. Throughout the last recent years, the vehicle manufacturers developed electronic means to control engine functions and diagnose engine problems. The currently established standard for vehicle diagnose system is known as OBD-II (on-board diagnostics), which has been introduced in the mid-'90s. The OBD-II provides almost complete engine control and enables also monitoring of parts of the chassis, body and accessory devices by the means of sensors as well as diagnostics of control network of a vehicle. Conventionally, OBD-II signals are most often sought after in response to a “Check Engine Light”, which appears for instance on a dashboard, or in consequence to drive ability problems, which may be experienced by the driver with the vehicle. Data provided by OBD-II enables and preferably simplifies often to pinpoint the specific component that has malfunctioned such that substantial time and cost are saved in comparison to traditional guess-and-replace repairs.

The service industry designates such a check engine light provided on a dashboard as a malfunction indicator light typically abbreviated as MIL. Conventionally, the malfunction indicator light is provided to show three different types of signals. For instance, an occasional flashing malfunction indicator light (MIL) may indicate momentary malfunctions, an constantly illuminated malfunction indicator light (MIL) may indicate that the problem is of a more serious nature such as affecting the emissions output or safety of the vehicle, and persistently flashing malfunction indicator light (MIL) may be an indication of a major problem, which might cause serious damage if the engine is not stopped immediately. In all cases a “freeze frame” of all sensor readings at the time of malfunction indication (independent from the kind of malfunction as described above) is recorded by any central computer of the vehicle or preferably the on-board diagnostics (OBD).

Hard failure signals caused by serious problems will cause the malfunction indicator light (MIL) to be illuminated any time the car is running until the problem is eliminated for instance by a garage and the malfunction indicator light (MIL) and the on-board diagnostics (OBD) is reset, respectively. Intermittent failures, which are typically indicated by an occasional flashing malfunction indicator light (MIL), typically depend on momentary conditions such that the fundamental problem might be not located. The freeze frame of the car's condition captured at the time of malfunction can serve as valuable basis for diagnosing such intermittent problems. However, in typical implantations the freeze frame will be erased in case the vehicle completes three driving cycles without a re-occurrence of the fundamental problem.

The free frame represents a set of sensor data or information, respectively, where one or more sensor data are coded on the basis of pre-defined service codes. Such service codes include, but not limited thereto, knock sensor operation data, FI pulse width, ignition voltage, individual cylinder misfires, transmission shift points, ABS break condition data, and the like. In dependence on the vehicle manufacturer and model, the set of sensor data comprised in a freeze frame may include up to several hundreds of individual sensor information. Vehicles vary in the compilation they will support.

With reference to FIGS. 1 and 2, a typical data exchange procedure in accordance with a system arrangement according to an embodiment of the present invention will be described. Assume that an on-board diagnostics (OBD) 200, which supports freezing of sensor data, on the basis of which the functioning of a vehicle and components thereof can be monitored, respectively. This means that at least crucial data for proper vehicle functioning is obtained by the means of the on-board diagnostics (OBD) system 200. The freezing operation may be initiated and performed on detection of a malfunction, which malfunction detection can detected by the board diagnostics (OBD) 200 and a component of the vehicle indicating malfunction to the board diagnostics (OBD) 200, respectively, or the freezing operation may be initiated and performed in response to a trigger being based on a time information as well as driving distance information.

With reference to operation S10 shown in FIG. 2, the obtained data captured in accordance with the freezing or a part of the obtained data can be obtained via the data interface 110 of the terminal interface 100, which is connected via the data interface 110 to the on-board diagnostics (OBD) 200. The data from on-board diagnostics (OBD) 200 is then transferred to a data processing means 120 of the terminal interface 100. In case of malfunction an error code is transmitted from the on-board diagnostics (OBD) 200 via the data interface 110 to processing means 120. Further, the error code data is processed by the means of the data processing means 120, where it may be identified as a critical error, which may be a malfunction, which affects normal vehicle operation, or which may be malfunction of such a nature that service is required.

In a next operation, a visual indication or any other indication can be switched by data processing means 120 in order to indicate to the driver (user) that a malfunction or any other condition has been detected, which requires service. Preferably, the indication is operable with a visual indication such as the malfunction indicator light (MIL) (not shown in FIG. 1) or any other visual indication, which informs the driver/user about the malfunction and the required driver/user action in accordance with the detected (malfunction) condition. For instance the indication informs the driver/user to call a service center 300 for service. Then, it is assumed that the driver/user decides whether to make a call to the service center 300 or not.

It should be further assumed that the driver/user uses its mobile phone 450 to call the service centre 300 via any public land mobile network (PLMN) 400, which supports voice/audio communications service. The public land mobile network can be any mobile communication network supporting one or more of the currently employed standards for mobile communications or any future standard for mobile communications. In particular, the public land mobile network can be a mobile communications network supporting at least one of the (cellular) communications standards including GMS (Global Mobile Communications System), any CDMA (Code Division Multiple Access) Standard such as IS-136 and IS-95, IDEN, and any WCDMA (wide-band code division multiple access) standard including UMTS (Universal Mobile Telecommunications System), CDMA2000, and the like.

In operation S11 of FIG. 2, the service call is established by the user by the means of the mobile phone 450 operable with the public land mobile network 400 to the service center 300 connected thereto. After establishment of the call, initiation, verification/authentication, and data exchange between terminal interface 100 and a server 310 of the service center 300 will be preformed. In order to enable communication between terminal interface 100 and server 310, a mobile communications standard independent information transmission methodology is provided by the terminal interface 100. The terminal interface 100 includes 1 modem 130, which is connected to the data processing means 120 of the terminal interface 100 and has a microphone and a loudspeaker for audio signal communication with mobile phone 450 as well as a corresponding loudspeaker and microphone of the mobile phone 450. This means that the user is intended to put the speaker of the mobile phone 450 close to the microphone of the terminal interface 100 (which might be visually depicted) such that audio signal communication from the speaker of the mobile phone 450 to the microphone coupled to the modem 130 is possible. Furthermore, the user is intended to put the microphone of the mobile phone 450 close to the speaker of the terminal interface 100 (which might be visually depicted, also) such that audio signal communication from the speaker coupled to the modem 130 to the microphone of the mobile phone 450 is possible. To support the acoustic coupling of the modem 130 and the mobile phone 450, a coupling means (not shown) can be provided, which for instance includes the audio interface of the modem (including the microphone and speaker connected to the modem) and any kind mechanical arrangement functioning as a seating, retainer, or support adapted for accepting the mobile phone 450. Such a mechanical arrangement may be useful to ensure a substantially sufficient acoustic coupling of the audio interface of the mobile phone 450 and the acoustic interface of the modem 130.

Preferably at the same time, the service center as well as the server 310 thereof begins transmission of data coded as audio signals. In a first operation S20, initiation of the data communication between terminal interface 100 and server 310 is performed. The initiation can preferably be based on a signal sequence (composed of one or more pre-defined or random signals) transmitted from the server 310 via the mobile phone 450 to the modem 130 (and might also be used for encryption/digital signature purposes). As soon as the terminal interface 100 and the data processing means 120 thereof receive the sequence and identifies the sequence as valid data the communication connection to the service center 300 can be established, preferably by back-transmitting a corresponding response to the initiation request.

Thereafter, the service center 300 may use a terminal identifier or an identifier provided by the mobile phone 450 (e.g. the telephone number, a subscriber identifier and the like) to establish and decide whether the vehicle implementing the terminal interface 100 is registered for services provided by the service center 300. The verification for registration, which allows access to the services of the service center 300, is operated for instance by the means of verification request and response transmissions transmitted between server 310 and terminal interface 100 as shown in operation S30 of FIG. 2. For user verification purpose, the service center 300 may comprises or may be associated with a subscriber data base (not shown) that stores subscription data relating to subscription information of users registered for services provided by the service center 300. The subscription data can comprise for instance a telephone number, any identifier obtainable from a subscriber identification module (SIM) of the mobile phone 450, or any other identifier allowing for identifying the user. In case the verification fails the service center 300 may terminate the connection to the terminal interface 100 and the mobile phone 450, respectively. In case the verification is approved by the service center 300, the terminal interface 100 sends one or more signals coding data generated by the processing means 120 via the modem and the mobile phone 450 to the server 310. The signal transmission can be initiated independently by the terminal interface 100 or can be initiated by a request for transmission originating from the server 300. A corresponding data exchange operation is illustrated with reference to operation S40 in FIG. 2. It should be understood that the data exchange operation S40 is operable with exchanging data and/or instructions originating from the data processing means 120 to be transmitted to the server 310 as well as data and/or instructions originating from the server 310 to be transmitted to the data processing means 120. Hence, the data exchange operation S40 may include one or more transmissions of data and/or instructions in-between the terminal interface 100 and the server 310 from as well as to either one thereof. Furthermore, the data/instruction exchange between may also include data/instruction communications between server 310 and on-board diagnostics 200 via the modem 130, data processing means 120 and data interface 110, which couples the terminal interface 100 to the on-board diagnostics 200.

Referring back to the data exchange operation S40, once the call connection is established error code data and/or other monitored data is transferred by the modem 130 via the established voice/audio communication established to the service center 300 and the server 310 by the means of the mobile phone 450. The data is passed via the modem (i.e. and its audio signal interface comprising its microphone and its speaker) converting the data to one or more audio signals the audio interface of the mobile phone 450 (i.e. its microphone and its speaker) through the audio signal connection 20, the radio frequency signal connection 30 of the public land mobile network (PLMN) 400 and its backend communication network to the processing data server 310 of the service center 300 connected to the public land mobile network (PLMN) 400 via any communication network such as a public subscriber telephone network (PSTN), wide area network supporting voice/audio communications and the like. On sever side the data is preferably stored and processed. Once data is stored and processed by the service center 300 a confirmation and back response may be returned to the terminal interface 100 via the above described connection. After successful data transmission, the connection is relieved or closed accompanied with a voiced and/or visual notification. Referring to operations S50 and S55 of FIG. 2, a relieve of the voice/audio communication connection between mobile phone 450 and service center 300 may be performed via a hang-up indication transmitted to the mobile phone 450, which may include a stop indication communicated by the mobile phone 450 to the modem 130, where the stop indication signalizes the end of communication.

After the communication between the service center 300 and terminal interface 100 via the mobile phone 450 is brought to end preferably from side of the service center 300 further service responses are possible.

For instance, the service center 300 may inform the driver/user about further proceedings, which information may include transmission of a message via for instance a messaging service (e.g. short message service (SMS) or multimedia message service (MMS)) including instructions to be performed by the driver/user. For example, such instructions may comprise information about the clearing of the error state of the terminal interface 100, which is applicable in case that the indicated malfunction is not critical. Alternatively, the message may comprise information about the nearest service station, which is informed about the malfunction on the basis of the data transmitted before to the service center 300. This means that the Service staff will have all the data about the malfunction preferably with diagnose and instructions required for repair. Further, the service center 300 having a customer support 320 may call back for voice guidance of the driver/user. It should be noted that the aforementioned response scenarios of the service center 300 are not limited to the described ones. Depending on the service organization scheme and capabilities of the service organization further response scenarios are conceivable.

Alternatively to the above described use case of a malfunction reporting use case, the arrangement shown in FIG. 1 may be also used for monitoring/service tasks. The monitoring data is obtained by the means of the on-board diagnostics (OBD) system 200. The monitored data may be continuously obtained by the on-board diagnostics (OBD) system 200. Alternatively, the obtaining of the monitoring data may be triggered by a time signal which may be generated upon manual interaction of the driver/user, a (pre-defined) moment in time, a (pre-defined) period of time, a (pre-defined) mileage reading of the odometer, a pre-defined distance, and the like. The monitored data is communicated (continuously and/or packet-wise) to the terminal interface 100 via its data interface 110 and can then be processed with its data processing means 120. The terminal interface 100 is preferably arranged for (locally and temporarily) storing the data.

In response to a trigger, which may be generated upon manual interaction of the driver/user, a (pre-defined) moment in time, a (pre-defined) period of time, a (pre-defined) mileage reading of the odometer, a pre-defined distance, a (pre-defined) threshold relating to an amount of stored data, a (pre-defined) threshold relating to a fill level of the storage arranged for storing the data, a quality of the data, and the like, the processing means 120 informs the driver/user that a communication connection to the service center 300 should be established. Preferably, the driver/user is informed by the means of a visual indication (not shown in FIG. 1).

On indication, the user can decide whether to make a call to the service center 300 or not. Assume that the driver/user has decided to make a call; the driver/user uses the mobile phone 450 to call the service centre 310 via the public land mobile network (PLMN) 400, to which the mobile phone 450 is subscribed. The monitoring call is established by the mobile phone 450 such as mentioned above with reference to operation S11. After establishment of the call, initiation, verification/authentication, and data exchange between terminal interface 100 and a server 310 of the service center 300 will be preformed. Details about the operations are described above and reference thereto should be given.

In this use case no further action is taken from a side of terminal interface 100 and service center 300, respectively. The transmission of the monitoring data enables monitoring and registering of the data obtained by the on-board diagnostics 200 by the server 310 to establish summary over time thereof.

With reference to FIG. 3, a second embodiment of the present invention is illustrated. The arrangement shown in FIG. 3 illustrates a terminal interface 100 for monitoring, maintenance, and service data exchange comprising an interface for coupling to an appliance 250, from which monitoring maintenance, and service data is obtained, and an interface to a mobile phone 450, which enables voice/audio communication form the terminal interface 100 to a service center 300 or, vice versa, from the service center 300 to the terminal interface 100. The data transmission is performed via a voice/audio communications channel established in-between the mobile phone 450 and the service center 300 preferably via a public land mobile network 400. Alternatively, data may be transferred directly from the terminal interface 100 or the appliance 250 via a communications connection 50 to the service center 300 and, vice versa, from the service center 300 via the communications connection 50 to the terminal interface 100 or the appliance 250.

One difference between the arrangement of FIG. 1 illustrating an embodiment of the present invention and the arrangement of FIG. 3 illustrating another embodiment of the present invention is an optional additional communication connection 50 between the appliance 250 or the terminal interface 100 and the service center 300. It should be noted that such an optional additional communication connection can also be provided in the embodiment illustrated in FIG. 1, where the optional additional communication connection enables direct communication between the terminal interface 100 or the on-board diagnostics 200 and the service center 300. Such an additional communication connection may use any currently available communication technology or any future communication technology including for instance GSM (Global System for Mobile Communications), GPRS (General Packet Radio Services), EDGE (Enhanced Data for GSM Evolution), UMTS (Universal Mobile Telecommunication System), any IEEE 802.xx standard including especially WiFi, and wire-based network technology including especially WAN/LAN (Wide Area Network/Local Area Network) technologies, power-line network technology and PSTN (Public Subscriber Telephone Network); just to illustrate a selection of currently available standards.

The embodiment illustrated in FIG. 3 refers to another use case, where the appliance 250 primarily relates to non-mobile appliances or appliances which are located within a pre-defined area. The pre-defined area should be understood as relatively fixed in comparison to the mobility of a vehicle. This means that such appliance with are essentially fixely located or at least located in a well-defined area can be connected to any network operated in accordance with any aforementioned communication technology. In other words, the appliance can be implemented for direct (and active) data/instruction communications. Nevertheless majority of appliances especially including household appliances such as air conditioner, dishwasher, freezer, microwave oven, television, water heater, etc. are still not enabled for direct (and active) data/instruction communications. Such an enablement may be principally possible due to the fact that such appliances are typically processor and/or controller controlled, where the processor/controller is conventionally software controlled.

The terminal interface 100 is intended to be used in conjunction with a variety of different appliance such that the implementation and functionality of the data interface 110 is to enable direct communication between terminal data processing means 120 and one or more processing means and/or one or more sensors of the appliance. The main functionality of the processing means 120 is based on processing and storing functionality of data obtained, retrieved, received, and/or collected from the appliance. Beside that the processing means 120 of the terminal interface 100 is configured to initiate monitoring, maintenance, and service calls to the service center 300.

In the following, a typical service data exchange procedure is described with respect to the embodiment shown in FIG. 3. Due to the analogy in implementation, references will be also made to the operational sequence described with reference to FIG. 2. Moreover, the procedure is essentially in analogy to those described with reference to FIG. 1.

Firstly, service data transfer is initiated by a user by the means of the mobile phone 450, which is used to establish a voice/audio communication connection on the basis of a voice call to the service center 300. The voice call is established via the radio frequency interface of the mobile phone 450 to the public land mobile network (PLMN) 400, which is for instance connected via a traditional public land subscriber line to the service center 300 and the server 310 thereof.

As aforementioned, speaker of the mobile phone 450 has to be put into proximity of the microphone connected to the modem 130 of the terminal interface 100. Likewise, the microphone of the mobile phone 450 has to be put into proximity of the speaker connected to the modem 130 of the terminal interface 100. The proximity requirement addresses the fact that the data communicated between the terminal interface 100 and the service center 300 is transferred in a converted audio signal coding. The proximity serves for minimizing interference.

Preferably at the same time, the service center as well as the server 310 thereof begins transmission of data coded as audio signals. In a first operation S20, initiation of the data communication between terminal interface 100 and server 310 is performed. The initiation can preferably be based on a signal sequence (composed of one or more pre-defined or random signals) transmitted from the server 310 via the mobile phone 450 to the modem 130 (and might also be used for encryption/digital signature purposes). As soon as the terminal interface 100 and the data processing means 120 thereof receive the sequence and identifies the sequence as valid data the communication connection to the service center 300 can be established, preferably by back-transmitting a corresponding response to the initiation request.

Thereafter, the service center 300 may use a terminal identifier or an identifier provided by the mobile phones (e.g. the telephone number, a subscriber identifier and the like) to establish and decide whether the vehicle implementing the terminal interface 100 is registered for services provided by the service center 300. The verification for registration, which allows access to the services of the service center 300, is operated via a verification request and response transmissions transmitted between server 310 and terminal interface 100 (as shown in operation S30 of FIG. 2). In case the verification fails the service center 300 may terminate the connection to the terminal interface 100 and the mobile phone 450, respectively. In case the verification is approved by the service center 300, the terminal interface 100 is enabled to send one or more signals coding data generated by the processing means 120 via the modem and the mobile phone 450 to the server 310 or vice versa.

After successful initiation and verification/authentication, the data exchange procedure starts. The data/instruction exchange is operable bi-directional. This means that for instance monitoring, maintenance, and/or service data and/or sensor data obtainable from the appliance 250 is transmitted via the voice/audio communication channel established between terminal interface 100 and service center 300 can be transmitted. Likewise, the service center 300 may transmit instructions and/or data to the terminal including for instance one or more new parameters for reconfiguration of the appliance or new firmware data in form of one or more data packets. After data exchange, the voice/audio communication connection between mobile phone 450 and service center 300 is relieved.

It should be noted that in case the voice/audio communication channel used for transmission is subjected to interference or collapses for any reason parameter reconfiguration or new firmware data should not be set/installed until an error-free transmission has been completed. A successful data transmission may be indicated to the user, preferably visually indicated by the means of a visual indication (not shown) and/or audio signal or voice conformation for instance via the speaker of the terminal interface 100. Otherwise the user might be informed also by the means of a visual indication provided by the terminal interface 100 or from side of the service center 300 for example via a SMS to repeat the data exchange procedure. A successful data transmission could be registered on side of service center 300, where all the changes regarding certain appliance 250 may be stored on processing the server 310, which handles the data communication with the terminal interface 100.

In a final operation, the reconfiguration of the appliance can be performed on the basis of the reconfiguration parameters or the new firmware data can be installed. The reconfiguration and/or installation process may be controlled by the appliance 250 and its processing means or with the help of the terminal interface 100 and its processing means 120 and interface 110, respectively.

Next, a further used will be described with reference to the arrangement of FIG. 3 according to an embodiment of the present invention. It should be assumed that the appliance 250 is also connected via an additional communication connection 50 to the service center 300, where the additional communication connection 50 enables direct communication between them.

This use case might be designated maintenance call applicable with appliance software parameter reconfiguration or for appliance firmware upgrade. In this use case, the phone call might not be initiated by the malfunction indication light or sound warning indicating operational fault but might be initiated from the service center 300. This means that the service center 300 makes the customer/user of the appliance 250 aware that a call to the service center 300 is recommended or required. Such a notification may be done either by voice call or by sending a message such as a short message or multimedia message to the mobile phone 450 of the customer/user.

Thereafter, it should be assumed that the user/customer, which is made aware to call the service center, intends to initiate the call to service center 300. The call is initiated by the user/customer with the help of the mobile phone 450, which is used to establish a voice/audio communication connection on the basis of a voice call to the service center 300. The voice call is established via the radio frequency interface of the mobile phone 450 to the public land mobile network (PLMN) 400, which is for instance connected via a traditional public land subscriber line to the service center 300 and the server 310 thereof. As aforementioned, speaker of the mobile phone 450 has to be put into proximity of the microphone connected to the modem 130 of the terminal interface 100. Likewise, the microphone of the mobile phone 450 has to be put into proximity of the speaker connected to the modem 130 of the terminal interface 100. The proximity requirement addresses the fact that the data communicated between the terminal interface 100 and the service center 300 is transferred in a converted audio signal coding. The proximity serves for minimizing interference. Preferably at the same time, the service center as well as the server 310 thereof begins transmission of data coded as audio signals. In a first operation S20, initiation of the data communication between terminal interface 100 and server 310 is performed. The initiation can preferably be based on a signal sequence (composed of one or more pre-defined or random signals) transmitted from the server 310 via the mobile phone 450 to the modem 130 (and might also be used for encryption/digital signature purposes). As soon as the terminal interface 100 and the data processing means 120 thereof receive the sequence and identifies the sequence as valid data the communication connection to the service center 300 can be established, preferably by back-transmitting a corresponding response to the initiation request. Thereafter, the service center 300 may use a terminal identifier or an identifier provided by the mobile phones (e.g. the telephone number, a subscriber identifier and the like) to establish and decide whether the vehicle implementing the terminal interface 100 is registered for services provided by the service center 300. The verification for registration, which allows access to the services of the service center 300, is operated via a verification request and response transmissions transmitted between server 310 and terminal interface 100 (as shown in operation S30 of FIG. 2). In case the verification fails the service center 300 may terminate the connection to the terminal interface 100 and the mobile phone 450, respectively. In case the verification is approved by the service center 300, the terminal interface 100 is enabled sends one or more signals coding data generated by the processing means 120 via the modem and the mobile phone 450 to the server 310 or vice versa. However, the additional direct communication connection is available, which might be assumed to be faster. Consequently, after successful initiation and verification/authentication, the data exchange procedure between appliance 250 and service center 300 begins using the additional direct communication connection 50. Furthermore, the voice/audio communication connection between mobile phone 450 and service center 300 has been essentially used for verification and/or authentication and not required anymore such that the voice/audio communication connection can be relieved.

The data/instruction exchange via the direct communication connection 50 is operable bi-directional. This means that for instance monitoring, maintenance, and/or service data and/or sensor data obtainable from the appliance 250 is transmitted via the voice/audio communication channel established between terminal interface 100 and service center 300 can be transmitted. Likewise, the service center 300 may transmit instructions and/or data to the terminal including for instance one or more new parameters for reconfiguration of the appliance or new firmware data in form of one or more data packets. It should be noted that in case the communication connection 50 used for transmission is subjected to interference or collapses for any reason parameter reconfiguration or new firmware data should not be set/installed until an error-free transmission has been completed.

The arrangements and use cases according to embodiments of the present invention described above in detail can be further modified including billing functionality. An illustration of such a modification is illustrated in FIG. 4 and described in detail with reference thereto. FIG. 4 illustrates substantially the arrangements of FIGS. 1 and 3 with billing/payment functionality according to another embodiment of the present invention.

The embodiment of FIG. 4 comprises in addition to those illustrated in FIGS. 1 and 3 a payment center 500 comprised by or connected to the service center 300. The payment center 500 is provided with a (audio) communication interface enabling for coupling the payment center 500 to the public land mobile network 400 via a voice/audio communication connection, a subscriber data base, eventually an interface to a customer relationship management (CRM), and a transaction interface connected to a financial information system. The subscriber data base may be arranged for storing data relating to subscribed users including for instance user identifiers, personal identification numbers (PIN), information about methods of payment including in particular credit card information and/or information about bank accounts, encryption information.

To enable the use of the payment service provided by the payment center 500, an account that belongs to the user should be set up in the payment center 500. The account set up is basically an agreement between the user and the payment center 500, wherein both parties agree in conditions of co-operation. Such contract conditions may comprise one or more user identifiers such as mobile phone numbers or SIM card numbers, information about an intended method of payment, e.g. money transfer, credit card, etc., optionally additional agreements and services, which may increase the security of both parties such as transaction limits, security/authentication codes, encryption services etc., and optionally additional services which increase the flexibility of the user, e.g. multiple accounts, etc. Preferably, the amount may be countable to a telephone bill or a prepaid account. The user might be allowed for altering one or more conditions of the agreement, which are preferably stored in the subscriber data base associated with the payment center 500, by the means of user support services offered by the payment center 500 via for instance internet services, WAP-based services and similar services. An additional authorization center (not shown) may be provided, which is arranged to assign to each user a specific identification code. The assignment can be performed in response to a request of the user or within the framework of business policy. Such a specific identification code allows preventing reveal of the mobile phone number of the user to other parties involved such that protection of privacy of the user can be guaranteed when participating in the system of invention.

Next, a typical payment procedure will be briefly described. Assume that a voice/audio communication connection is established between mobile phone 450 and the payment center 500 via the public land mobile network (PLMN) 400. This means that the terminal interface 100 is capable for communicating with the payment center 500. In response to an initiation of the communication connection between mobile phone 450 and the payment center 500, verification, and/or authentication of the user is performed on the basis of an identifier provided by the terminal interface 100 or the mobile phone 450 as well as the subscriber data base.

After the successful verification described above in detail, the user may be requested to input an additional security/authentication (PIN) code. The user can input such a code by means of the keypad of the mobile phone 450. The payment center 500 checks the security/authentication code received from the mobile phone 450 via the public land mobile network (PLMN) 400 against information provided by the subscriber data base. If the verification/authentication is successful the payment center 500 may inform the user to put his mobile phone 450 onto the acoustic coupling means of the terminal interface 100.

Hence, the payment center 500 is enabled to transfer required transaction data or payment data via the voice communication connection established between the mobile phone 450 and the payment center 500 via the public land mobile network 400. Such transaction data can be coded by means of cryptographic technology implemented in the processing means 120 on the side of the terminal interface 100 and in the payment center 500. The processing means 120 controls the reception of transaction data on the side of the terminal interface 100. Following, the payment center 500 may also check whether the transaction data correspond to the specifications and conditions on the user's account (transaction limits . . . ).

After successful completion of the above described payment procedure further operations may follow, especially data exchange between terminal interface 100 and server 310.

In summary, the microphone coupled to the modem 130 of the terminal interface 100 is employed to receive acoustic coded transaction information from the payment center 500. The code is used to pair terminal data and user data that may have been gathered from the mobile phone 450. Authentication and/or authorization may be operated via an additional direct communication connection connecting terminal interface 100 and payment center 500 as described with reference to FIG. 3 or via the speaker coupled to the modem 130 of the terminal interface 100 employed to transmit acoustic coded transaction response information.

In case the additional direct communication connection connecting the terminal interface 100 and the payment center 500 is available, the data communication between the terminal interface 100 and the payment center 500 is preferably operable via that additional direct communication connection after successful verification/authentication.

It is further to be noted, that in the description the expression “modem” is used to describe electric or electronic circuitry acting as a modulator/demodulator, for devices acting as modulators only, and for devices acting as demodulators only.

It should be noted that the employment of the modem 130 enabling encoding of data into acoustic data signals and decoding of acoustic data signals back into data guarantees that the presented concept on the basis of the arrangements according to embodiments of the present invention is applicable with any public communication network which supports voice/audio communication. To enable voice/audio communication such public communication networks guarantee the transmission of audio signals within a pre-defined lower and upper audio frequency limits at a pre-defined sampling rate. Although modem public communication network provide data communication services, the use of such data communication services require typically the adaptation to a plurality of proprietary interface technologies and interface standards.

This application contains the description of implementations and embodiments of the present invention with the help of examples. It will be appreciated by a person skilled in the art that the present invention is not restricted to details of the embodiments presented above, and that the invention can also be implemented in another form without deviating from the characteristics of the invention. The embodiments presented above should be considered illustrative, but not restricting. Thus the possibilities of implementing and using the invention are only restricted by the enclosed claims. Consequently various options of implementing the invention as determined by the claims, including equivalent implementations, also belong to the scope of the invention.

1. An interface terminal (100) arranged for interfacing between an electronic device (200, 250) and a service provider (300), wherein said interface terminal (100) comprises:
a data interface (110) adapted to enable data communication with said electronic device (200, 250);
modem means (130) enabling data communication between said interface terminal (100) and a terminal device (450) enabled for voice commutation in a mobile communications network (400); and
data processing means (120) coupled to said data interface (110) and said modem means (130) for processing data received from either of said data interface (110) and said modem means (130) and for generating data to be transmitted via said data interface (110) and/or said modem means (130);
wherein data is communicated between said interface terminal (100) and said service provider (300) via said terminal device (450) on a voice communication connection.

2. The interface terminal according to claim 1, comprising coupling means arranged for releaseably coupling said terminal device (400) to said interface device (100).

3. The interface terminal according to claim 1, compromising said modem means (130) arranged for converting acoustically coded information received from said terminal device (450) via an acoustic interface of said coupling means into converted data to be sent to said processing means (120) and for converting data received from said processing means (120) into acoustically coded information to be sent via said acoustic interface.

4. The interface terminal according to claim 3, wherein said acoustic interface provides an acoustic transducer for generating one or more acoustic signals and/or an acoustic sensor for detecting acoustic signals, wherein said acoustic interface is intended for acoustic coupling to an audio interface of said terminal device (100).

5. The interface terminal according to anyone of the claim 1, wherein said electronic device is an on-board diagnostic system (200) of a vehicle, which provides diagnostic data comprising diagnostic information and/or sensor information, wherein said data is to be transmitted to a service provider providing monitoring, support, and/or maintenance services for said vehicle.

6. The interface terminal according to claim 5, wherein said diagnostic data is to be transmitted in accordance with a malfunction indication, which is provided by said on-board diagnostic system (200) or generated by said interface terminal (100) on the basis of said diagnostic data.

7. The interface terminal according to claim 5, wherein said diagnostic data is buffered by said interface terminal (100), wherein said buffered diagnostic data is to be transmitted to said service provider to enable monitoring of an operation of said vehicle.

8. The interface terminal according to claim 1, wherein said electronic device is an appliance device (250), which operation is controlled on the basis of program code, wherein said appliance device (250) provides operation related data and/or sensor data, wherein said data provided by said appliance device is to be communicated to a service provider providing monitoring, support, and/or maintenance services for said appliance device.

9. The interface terminal according to claim 8, wherein said interface terminal is arranged to receive reconfiguration data from said service provider, which reconfiguration data is intended for reconfiguring said appliance device, wherein said reconfiguration data comprise reconfiguration parameters, program code for reconfiguration, and/or new program code for replacement.

10. The interface terminal according to claim 1, wherein said terminal interface (100) comprises a terminal identifier for establishing its authorization at said service provider.

11. The interface terminal according to claim 1, wherein said interface terminal (100) is arranged to transmit additionally payment-related information to said service provider offering payment transaction services.

12. A system comprising an interface terminal (100) arranged for interfacing between an electronic device (200, 250) and a service provider (300), wherein said interface terminal (100) comprises:
a data interface (110) adapted to enable data communication with said electronic device (200, 250);
modem means (130) enabling data communication between said interface terminal (100) and a terminal device (450) enabled for voice communication in a mobile communications network (400); and
data processing means (120) coupled to said data interface (110) and said modem means (130) for processing data received from either of said data interface (110) and said modem means (130) and for generating data to be transmitted via said data interface (110) and/or said modem means (130);
wherein data is communicated between said interface terminal (100) and said service provider (300) via said terminal device (450) on a voice communication connection.

13. The system according to claim 12, wherein said terminal device (450) is operable with any mobile voice communication technology.

14. The system according to claim 13, wherein said service provider (300) and said electronic device (200, 250) are connectable via a direct communication connection, which is used for data communication after establishing of an authorization via said terminal device (450) acoustically coupled to said modem means (130) of said interface terminal (100) and enabled for over-the-air communication with said mobile communications network (400).

15. The system according to claim 12, comprising additionally a payment center (500), which is comprised by or associated with said service provider (300), wherein said interface terminal (100) is arranged to transmit additionally payment-related information to said service provider offering payment transaction services.
